(19) United States
(12) Patent Application Publication
(10) Pub. No.: US 2025/0390834 A1
(43) Pub. Date: Dec. 25, 2025

(54) A SERVICE POINT FOR DISTRIBUTION OF A PLURALITY OF PARCELS AND A METHOD FOR CONTROLLING A PARCEL DISTRIBUTION AT THE SERVICE POINT

(71) Applicant: SwipBox Development ApS, Sønderborg (DK)

(72) Inventor: Allan KACZMAREK, Sønderborg (DK)

(21) Appl. No.: 18/877,316

(22) PCT Filed: Jun. 27, 2023
(86) PCT No.: PCT/EP2023/067419

§ 371 Date: Dec. 20, 2024

(30) Foreign Application Priority Data
Jun. 29, 2022 (EP) 22181976.6

(51) Int. Cl. G06Q 10/0836; G06Q 10/083

(52) U.S. Cl. CPC G06Q 10/0836; G06Q 10/0838

(57) ABSTRACT

A service point for distribution of a plurality of parcels is provided, wherein the service point includes a parcel shop being a manned service point for manually handing over parcels, the parcel shop including a storage room for storing the plurality of parcels, and a shop instruction unit including a display for displaying instructions; a parcel locker positioned inside the parcel shop or positioned in a near vicinity of the parcel shop, the parcel locker including a plurality of compartments for storing parcels and the plurality of compartments including a compartment door provided with a lock; and a locker communication unit, a service point controller including a computer readable storage for storing thereon a parcel ID of each of the plurality of parcels and for storing a service point parcel distribution including a parcel position of each of the plurality of parcels within the service point; a service point communication unit for wired or wireless communication with the shop instruction unit, the locker communication unit, third-party devices and optionally, a distribution server; and a service point processor configured to send instructions to the shop instruction unit about refilling the parcel locker as a function of the service point parcel distribution.

### CROSS-REFERENCE TO RELATED APPLICATIONS

This application is a national stage of PCT Application No. PCT/EP2023/067419, having a filing date of Jun. 27, 2023, which is based on EP Application Serial No. 22181976.6, having a filing date of Jun. 29, 2022, the entire contents both of which are hereby incorporated by reference.

### FIELD OF TECHNOLOGY

The following relates to a service point comprising both a parcel shop and a parcel locker, wherein receivers of parcels can collect parcels at the service point from either the parcel shop or the parcel locker, wherein a service point controller ensures that the parcel locker is continuously refilled with parcels in order to increase the efficiency of the service point.

### BACKGROUND

Today, parcel shops and parcel lockers are used for distributing the increasing number of parcels being sent due to e-commerce.

Parcel shops are, however, relatively labor intensive as an employee must find the parcel to be collected and the receiver must show proof of identity before collecting the parcel and in some cases, it requires a signature.

Parcel lockers are not labor intensive as a user can unlock a compartment using a third-party device, like a smart phone, or by using a touch screen forming part of the parcel locker. However, the capacity of the parcel lockers is lower than parcel shops, partly because most parcel lockers are only filled with parcels once a day. Furthermore, some parcels are only collected after several days. This will further lower the overall throughput of parcels in the parcel lockers.

Thus, there is a need for a solution which can reduce the labor intensity of parcel shops by increasing the throughput of parcel lockers.

### SUMMARY

An aspect relates to a service point solving challenges related to manned parcel shops and efficient usage of parcel lockers.

An aspect of embodiments of the invention is achieved by a service point for distribution of a plurality of parcels.

The service point comprises a parcel shop being a manned parcel shop for manually handing over parcels. The parcel shop comprises
a storage room for storing the plurality of parcels, and
a shop instruction unit including a display for displaying instructions.

The service point further comprises a parcel locker positioned inside the parcel shop or positioned in a near vicinity of the parcel shop. The parcel locker comprises
a plurality of compartments for storing parcels and the plurality of compartments comprise a compartment door provided with a lock; and
a locker communication unit.

The service point further comprises a service point controller comprising
a computer readable storage for storing thereon a parcel ID of each of the plurality of parcels and for storing a service point parcel distribution including a parcel position of each of the plurality of parcels within the service point;
a service point communication unit for wired or wireless communication with the shop instruction unit, the locker communication unit, third-party devices and optionally, a distribution server; and
a service point processor configured to send instructions to the shop instruction unit about refilling the parcel locker as a function of the service point parcel distribution.

Thereby, a combined service point is provided which reduces the need for manual labour while increasing a parcel throughput of a parcel locker. The effect will be even greater if additional algorithms are used for optimising the parcel distribution between the parcel shop and the parcel locker.

The parcel shop may be any common parcel shop, and the parcel shop may be part of a larger store or shop which provides other services. Likewise, the storage room may be a common storage room.

The shop instruction unit may be a computer with a display or a laptop or a tablet or smart phone or smart device. The shop instruction unit may be two or more devices such as a computer with a display and a tablet where the tablet is portable and used when refilling the parcel locker.

The shop instruction unit will provide instructions to the employees at the parcel shop about refilling the parcel locker as a function of the service point parcel distribution. This may be in the form of that 50% of the plurality of compartments are empty and that the parcel locker must be refilled. It is more efficient to deliver parcels through the parcel locker as the computer system ensures that the correct receiver of a parcel receives the parcel, while manual handing also requires manual confirmation. Thus, the employee is also enticed to refill the parcel locker.

The parcel locker may be any known parcel locker having the features described above. The parcel locker may receive power from a battery, a power cord or both. The locker communication unit may be configured for wireless or wired communication such as ethernet and/or Bluetooth and/or WLAN and/or USB and/or Wi-Fi and/or NFC.

The locks of the plurality of compartments are controlled electronically and will open once the locks receive instructions to open. Parcels may then be stored in or collected from the open compartments. The instructions will typically be sent from the locker communication unit to the lock.

The parcel locker will in most cases be positioned inside the parcel shop. This will shorten the distance between the storage room and the parcel locker and as a result the refilling of the parcel locker can be performed faster. However, the parcel locker can be positioned in the near vicinity of the parcel shop such as at the front of the parcel shop or at the parking lot of the parcel shop or the like. If the parcel locker is positioned in the near vicinity, then the parcel locker should be positioned as close to the parcel shop as possible to increase the refilling efficiency.

Throughout this application parcel locker is mentioned in singular, however, there may be one, two or more parcel lockers at the service point.

The service point controller functions as a local control centre for the service point as it will control the service point parcel distribution between the storage room and the parcel locker. The service point controller will be programmed for optimising the throughput of the parcel locker and thus, the service point processer will send instructions to the shop instruction unit about refilling the parcel locker as a function of the service point parcel distribution.

As an example, the service point may store 100 parcels, where 70 parcels are stored at the storage room and 30 parcels are stored in the parcel locker. After 8 hours, 30 parcels are collected from the storage room and 15 parcels are collected from the parcel locker. Thus, the service point parcel distribution will be left with 40 parcels that are stored at the storage room and 15 parcels that are stored in the parcel locker. In this case, the service point processor may send instructions to the shop instruction unit that the parcel locker should be refilled such that the service point parcel distribution will be left with 25 parcels in the storage room and 30 parcels in the parcel locker.

The service point controller further enables that the service point can manage receiving packages from multiple courier services without increasing the complexity at the service point or for the parcel shop since the service point controller manages the service point parcel distribution and is not affected by which courier service is used. Again, the collection of parcels from the parcel locker will likewise be simpler when the service point receives parcels from different courier services, as handling of the parcel is done electronically without the need of an employee, while the same employee might need to manually handle the handing over of a parcel differently depending on the courier service.

The service point controller may be in direct or indirect communication with a distribution server, which tracks all parcels in a distribution network including a plurality of parcel shops and/or parcel lockers. In embodiments the distribution server may further also track delivery of parcels for home delivery. The service point can run autonomously without receiving any instructions or information from an external distribution server. This will also ensure parcel delivery in case of a centralised breakdown.

In an aspect, the service point controller may, upon a collection request of a parcel having a parcel ID from a third-party device, be adapted to perform the following steps as a function of the position of the parcel;
transmitting instructions to the locker communication unit, which instructions causes the lock of the compartment holding the parcel with the parcel ID to unlock; or
transmitting instructions to the shop instruction unit for collecting and handing over the parcel with the parcel ID.

Thereby, the receiver of the parcel with the parcel ID will be able to collect the parcel by simply sending a collection request and the service point controller will ensure that instructions are sent in the correct direction i.e., either to the parcel locker or to the shop instruction unit from where the receiver can collect the parcel.

The service point controller may send information to the receiver about where to collect the parcel upon receiving the collection request. The receiver of a parcel with parcel ID may not be informed ahead of the collection request whether the parcel is positioned in the parcel locker or in the storage room, as this will allow changing the service point parcel distribution without confusing a receiver since the parcel to be collected may have been moved from the storage room to the parcel shop a few minutes before receiving the collection request and the receiver would believe that the parcel should be collected from the parcel shop if the information has not been pushed to the receiver. The service point controller tracks where the parcel is stored on a local level and thus, may simply inform the receiver without any confusion.

The device used by the receiver, or the service point controller may communicate with the distribution server about collection of the parcel having the parcel ID, such that the parcel is also tracked on a global level.

In an aspect, the service point controller may comprise a clock unit and the service point controller may be configured to storing a collection event and time of the collection event on the computer readable storage, thereby generating local historical event data. The service point processor is further configured to send instructions to the shop instruction unit about refilling the parcel locker as a function of the local historical event data and the service point parcel distribution.

Each service point has different collection patterns and the tracking of the collection pattern of parcels will enable the service point to optimise the service point parcel distribution and to choose the best timeslot for refilling the parcel locker. Many parcel shops in Denmark have a local minimum of busyness around 12:00 μm and thus, it may be an optimal timeslot for refilling the parcel locker. However, in some cases it may be more optimal to wait until 15:00 pm to refill the parcel locker such that more parcels could be collected from the parcel locker when refilling prior to rush hour from 16:00 μm to 18:00 pm. This should be seen as examples, as there will be a great spread between different parcel shops. The aim of the service point controller is to ensure that as many parcels are stored in the parcel locker as possible while making the refilling of the parcel locker as easy as possible, i.e., the refilling may be performed at times with lower business.

In embodiments, the storage room may comprise a storage room capacity and the parcel locker may comprise a parcel locker capacity, wherein the ratio between the parcel locker capacity and the storage room capacity is 1:2 or 1:3 or 1:4 or 1:5.

In an aspect, the service point is part of a convenience store or a supermarket or a retail store. This enables the receiver to collect parcels while doing everyday shopping.

In embodiments, the service point controller functions as a master controller, as the service point controller supports the employees at the convenience store or a supermarket or a retail store for when the parcel locker should be refilled such that decisions made by persons at the service point can be reduced as much as possible. Thereby, the additional workload of also being a service point controller is reduced which is important for convenience stores or supermarkets or retail stores as parcel handling is secondary business for attracting customers.

In an aspect of embodiments, the service point controller may receive historical store data of the convenience store or the supermarket or the retail store, where the historical store data includes time-sequenced busyness data. The service point controller is further configured to send instructions to the shop instruction unit about refilling the parcel locker as a function of the historical store data and the service point parcel distribution.

This will enable the service point controller to provide better instructions faster when setting up a service point according to embodiments of the invention. The service point may collect future data, however, it will take one year to receive one year of data. Thus, by utilizing the historical store data, the service point controller can provide better instructions from day 1.

In an aspect, the service point may be an autonomous service point and the decision whether a parcel is stored in the storage room or in the parcel locker is decided by the autonomous service point.

Thus, the service point can receive parcels and hand over parcels without communication with an external distribution server and without receiving instructions, the positions of the parcels within the service point. Thereby, the service point can function and handover parcels to receivers even if the external distribution server is down or not available. This will make the service point more robust.

In an aspect, the storage room may comprise a plurality of marked parcel positions, wherein the service point controller being configured to send instructions to the shop instruction unit about storing a parcel with a specific parcel ID at a specific marked parcel position and/or being configured to receive information of a parcel with specific parcel ID being stored at a marked parcel position.

Personnel of the parcel shop may simply place the parcels at specific marked parcel positions where there is space. The personnel may during the storing or afterwards, provide information to the service point controller about where the different parcels are positioned.

This will further enhance the instructions sent to the shop instruction unit as the instruction may be to take the parcel at parcel position 1-5 in the storage room and place the parcel in the parcel locker row 3 column 2. Also, the instructions may be to take parcel at parcel position 1-5 in the storage room and hand the parcel to a receiver. This will significantly increase the efficiency of the service point and the refilling of the parcel locker.

The marked parcel positions may be in the form of numbers and/or letters and/or symbols such that the marked parcel positions can be easily identified by an employee.

Furthermore, many distribution systems know the volume and shape of the parcels to a high degree. A parcel locker has pre-defined compartments with a static volume and static shape. Thus, the service point controller can in these situations further perform the step of refilling as a function to utilize the compartments such that the volume of the compartments is optimised.

In an aspect, the service point controller may track a parcel locker storage time for each parcel stored in the parcel locker, wherein the service point controller is further configured to send instructions to the shop instruction unit about replacing one or more parcels stored in the parcel locker as a function of the parcel locker storage time.

The handling of parcels will always be most efficient if the parcels are delivered through the parcel locker. However, this is not the case if the parcels are not collected. In many cases, a parcel is collected within one day, however, if the parcel is not collected within 24 hours, then the risk of the parcel not being collected or collected at a later time increases significantly. In these cases, the parcel is just taking up room in the parcel locker. Thus, the service point controller can further increase the efficiency by removing parcels which are not being collected.

In many cases, the service point controller will send instructions to remove and replace parcels after 24 hours of no collection since the last refilling.

In some cases, the service point controller may receive a collection pattern of the receiver of a parcel and the service point controller may send instructions according to the collection pattern. If the receiver in 80% of the cases collects parcels in the weekend, then the parcel should not be positioned in the parcel locker before the weekend as it will in 80% of the cases remain uncollected until the weekend. Furthermore, if the parcel has not been collected on a Sunday, then the parcel should be positioned in the storage room as it will likely not be collected before the next weekend.

An aspect of embodiments of the invention is achieved by a method for controlling a service point parcel distribution at a service point. In embodiments, the method comprises steps of
receiving at the service point, a plurality of parcels with parcel IDs;
   storing the plurality of parcels in the storage room and the parcel locker; and after a time period, the following step is performed as a function of instructions received by the service point controller;
   refilling the parcel locker by placing parcels from the storage room in the parcel locker.

As previously mentioned for the service point embodiment, this enables that more parcels are being delivered by the parcel locker which is more time efficient than the manually handing over of parcels at the parcel shop. The step of refilling is performed as a function of instructions received by the service point controller as the personnel may not know how many parcels have already been collected from the parcel locker.

In embodiments, the step of storing may also be solely performed as a function of instructions received by the service point controller.

Furthermore, the storing step and receiving step can be performed by multiple different courier services.

In an aspect, the step of refilling may be performed as a function of local historical event data and the service point parcel distribution, wherein the local historical event data includes collection events and time of the collection events.

This will further increase the efficiency of the service point, as the service point parcel distribution can be changed, where there historically is a low point in collection of the parcels.

In an aspect, embodiments of the method further comprise steps of
removing a parcel stored from the parcel locker and storing the parcel in the storage room, while storing a parcel from the storage room in the parcel locker;

wherein the step of removing is performed as a function of a parcel locker storage time of the parcels stored in the parcel locker.

As previously mentioned, the chance of a parcel being collected falls significantly within the first 24 hours. Thus, if a parcel is not collected within 24 hours, then the parcel is just taking up a compartment in the parcel locker and this decreases the parcel locker efficiency as the compartment in the parcel locker may distribute two, three or more parcels if the parcel is collected within 24 hours.

Thus, the removing and storing is in effect a single step of replacing a parcel in the parcel locker with a parcel from the storage room.

In an aspect, embodiments of the method may further comprise a step of
receiving a receiver collection pattern of the plurality of parcels from a distribution server, which receiver collection pattern includes historical data of collection times of receivers of the plurality of parcels,

wherein the step of storing, the step of refilling and/or the step of removing is performed as a function of the receiver collection pattern.

The different receivers of the plurality of parcels have individual collection patterns. Some receivers choose to collect the parcel before work or at a lunch break or after work, while others may only collect parcels at the weekend. The distribution server will have this data of the receivers and by utilizing this data, embodiments of the method and the service point becomes even more efficient as the service point parcel distribution is further chosen, such that the parcel locker is filled with parcels which is most likely to be collected within a short time period.

In an aspect, embodiments of the method comprise a step of
receiving a preferred collection time slot provided by a receiver of a parcel,

wherein the step of storing, the step of refilling and/or the step of removing is performed as a function of the preferred collection time slot.

This will further increase the efficiency, as the receiver is enabled to inform about a preferred collection time slot in which embodiments of the method will try to ensure that the parcel to be collected by the receiver is placed in the parcel locker.

An aspect of embodiments of the invention is achieved by a method for collection of a parcel with a parcel ID at a service point. In embodiments, the method comprises steps of
transmitting a collection request of a parcel with a parcel ID to the service point controller;
receiving from the service point controller, a parcel position of the parcel with a parcel ID;

wherein one of the following steps is performed as a function of the parcel position
transmitting instructions to the locker communication unit, which instructions cause the lock of the compartment holding the parcel with the parcel ID to unlock: or
transmitting instructions to the shop instruction unit for collection and handing over the parcel with the parcel ID; and
collecting the parcel with the parcel ID.

In embodiments, the method describes how a parcel is collected from a service point according to embodiments of the invention, wherein the service point controller is a central part as it directs the handing over of the parcel.

Depending on the relative position between the parcel shop and the parcel locker, the service point controller may inform the device whether the parcel is to be collected from the parcel shop or the parcel locker.

In an aspect, the step of transmitting a collection request is performed by a third-party device, wherein the third-party device is a smart phone or laptop or tablet or a local parcel shop unit.

In embodiments, the method enables that any device can be used as long as it can communicate with the service point controller.

### BRIEF DESCRIPTION

Some of the embodiments will be described in detail, with references to the following Figures, wherein like designations denote like members, wherein:

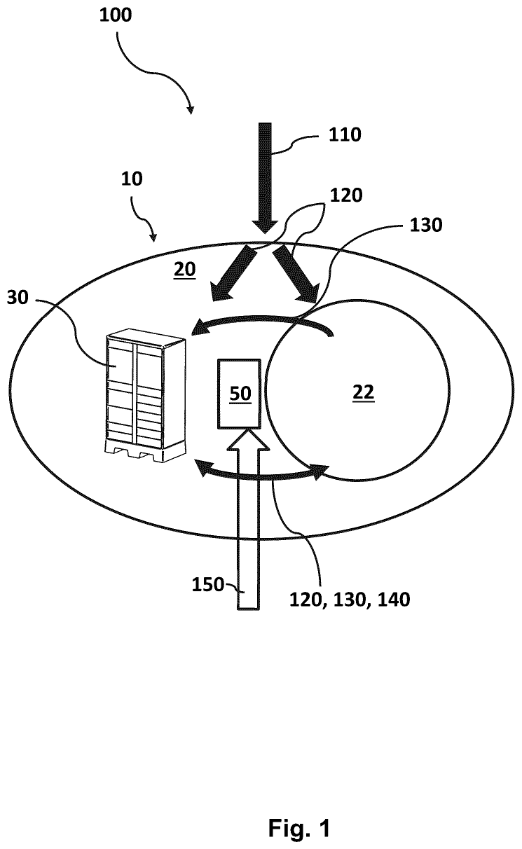

FIG. 1 illustrates controlling parcel distribution of a plurality of parcels at a service point comprising a parcel shop and a parcel locker according to embodiments;

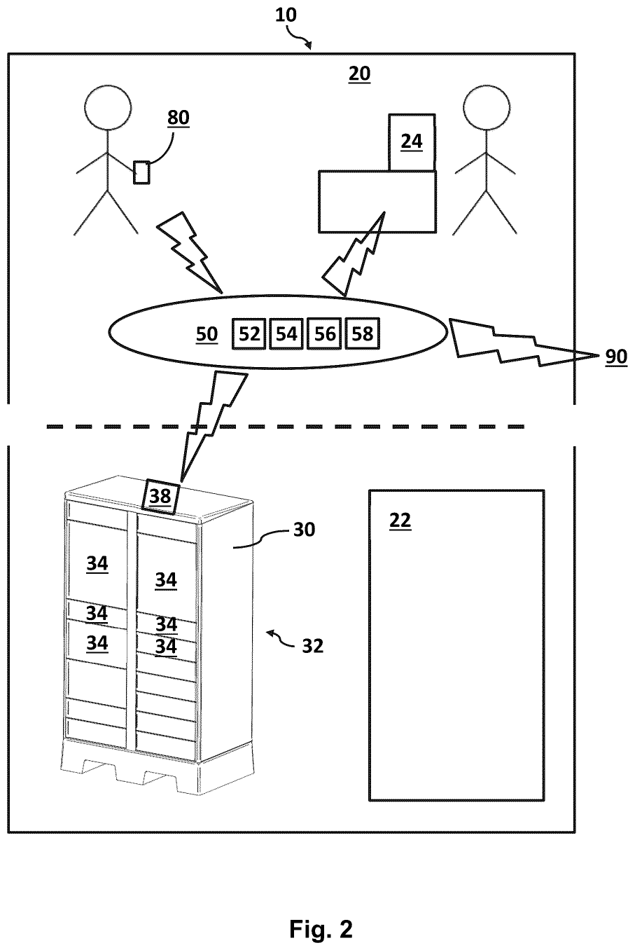

FIG. 2 illustrates a service point comprising a parcel shop and a parcel locker according to embodiments;

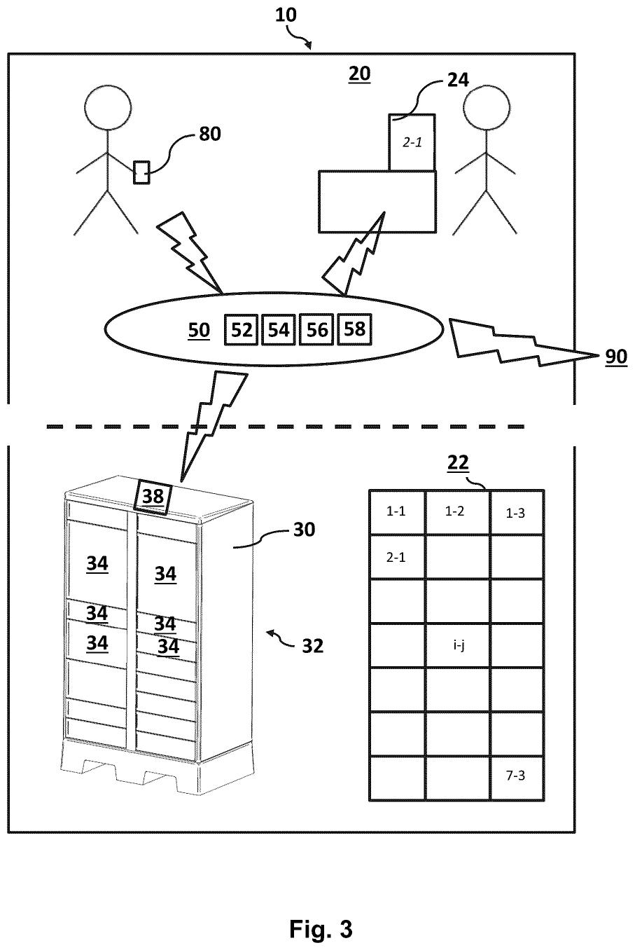

FIG. 3 illustrates a service point comprising a parcel shop and a parcel locker according to further embodiments;

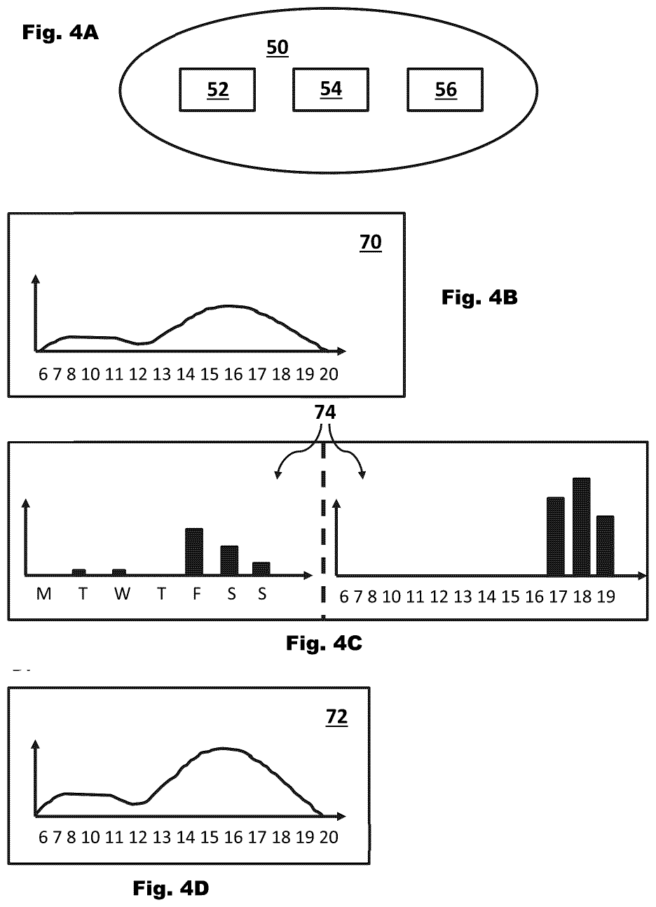

FIG. 4A-4D illustrate various data which can be utilized by a service point controller for optimising a service point; and

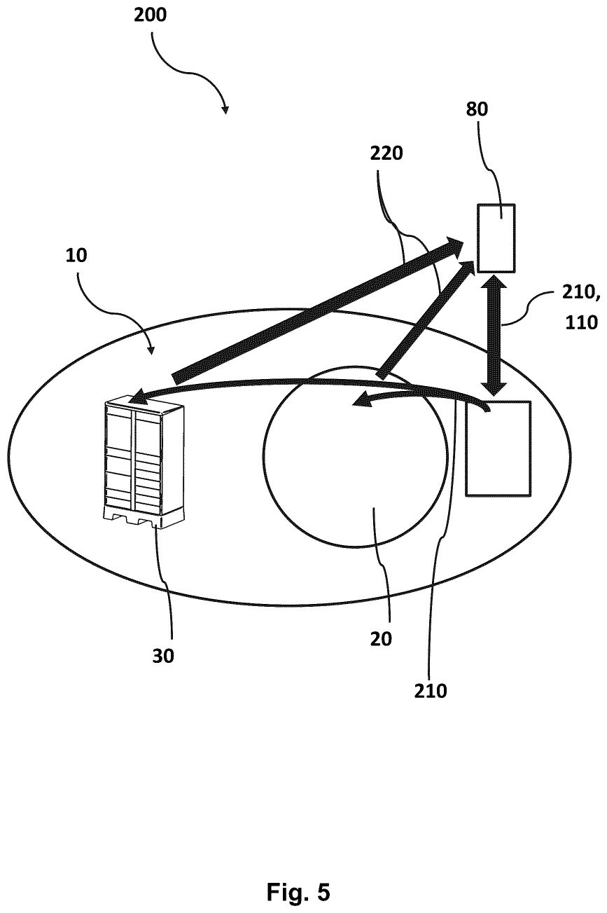

FIG. 5 illustrates a smart device transmitting a collection request to a service point controller of a service point.

### LIST OF REFERENCE NUMBERS

| Item | No |
|---|---|
| Service point | 10 |
| Parcel shop | 20 |
| Storage room | 22 |
| Shop instruction unit | 24 |
| Parcel locker | 30 |
| Plurality of compartments | 32 |
| Compartment door | 34 |
| Locker communication unit | 38 |
| Service point controller | 50 |
| Computer readable storage | 52 |
| Service point communication unit | 54 |
| Service point processor | 56 |
| Clock unit | 58 |
| Local historical event data | 70 |
| Historical store data | 72 |
| Receiver collection pattern | 74 |
| Third-party devices | 80 |
| Distribution server | 90 |
| Method for controlling a parcel distribution at a service point | 100 |
| Receiving | 110 |
| Storing | 120 |
| Refilling | 130 |
| Removing | 140 |
| Receiving | 150 |
| A method for collection of a parcel with a parcel ID at a service | 200 |
| point | |
| transmitting | 210 |

### DETAILED DESCRIPTION

FIG. 1 illustrates controlling a parcel distribution of a plurality of parcels at a service point 10 comprising a parcel shop 20 and a parcel locker 30. The service point 10 further comprises a service point controller 50 which is adapted to keeping track of the plurality of parcels and the parcel distribution between the parcel shop 20 and the parcel locker 30. Embodiments of the parcel shop 20, the parcel locker 30 and the service point controller 50 are described in greater detail in the later figures.

The service point 10 will receive 110, a plurality of parcels with parcel IDs. This step of receiving 110 may be performed one or more times per week or day from various courier services. The personnel or the courier will perform a step of storing 120 the plurality of parcels in a storage room 22 (not shown) of the parcel shop 20 and the parcel locker 30 in the simplest embodiment. The parcel locker 30 is filled with random parcels of the plurality of parcels until the parcel locker 30 is full and any remaining parcels will be stored 120 in the storage room 22. In embodiments, the step of storing 120 is performed as a function of instructions received by the service point controller 50.

The service point controller 50 may have information regarding parcel size of each parcel which is common in parcel distribution. Thereby, parcels are matched with parcel compartments 32 (shown but not marked in the present figure) with a complementary size such that the space is utilized. The service point controller 50 may also use local historical event data 70, historical store data 72 and receiver collection patterns 74 for generating the instructions related to the step of storing 120.

A step of refilling 130 the parcel locker 30 by placing parcels from the storage room 22 in the parcel locker 30 is performed after a time period as a function of instructions received by the service point controller 50. The time period can be any time period depending on how fast the parcel locker 30 is emptied.

Thereby, a method 100 for controlling a service point parcel distribution at a service point is performed, wherein the number of parcels in the parcel locker 30 is as high as possible at any time since it is more efficient if a parcel is collected from the parcel locker 30 than from the parcel shop 20.

There may be a further step of removing 140 a parcel stored from the parcel locker 30 and storing 120 the parcel in the storage room 22, while storing 120 a parcel from the storage room 22 in the parcel locker 30, wherein the step of removing 140 is performed as a function of a parcel locker storage time of the parcels stored in the parcel locker 30. If the parcel locker storage time exceeds 24 hours, then the chance of a parcel being collected drops significantly and the chance that the parcel is collected within the day or hour also drops significantly, i.e., the parcel will simply take up a parcel compartment 32. In this case, the service point controller 50 will provide instructions to replace the parcel with another parcel which has a higher chance of being collected. This will increase the throughput of the parcel locker 30 and thereby the entire service point.

There may be a further step of receiving 150 a receiver collection pattern 74 (not shown in FIG. 1) of the plurality of parcels from a distribution server 90, which receiver collection pattern 74 includes historical data for collection times of receivers of the plurality of parcels, wherein the step of storing 120, the step of refilling 130 and/or the step of removing 140 is performed as a function of the receiver collection pattern 74 for the purpose of increasing the efficiency of the service point 10.

FIG. 2 illustrates a service point 10 comprising a parcel shop 20 and a parcel locker 30.

The parcel shop 20 is a manned parcel shop for manually handing over parcels. The parcel shop (20) comprises a storage room (22) for storing the plurality of parcels, and a shop instruction unit (24) including a display for displaying instructions. The displayed instructions may cause the personnel of the parcel shop to collect a parcel or to refill the parcel locker 30 or remove a parcel from the parcel locker 30 or other actions related to the service point 10.

The parcel locker 30 is in this embodiment positioned inside the parcel shop 20. The parcel locker 30 comprises a plurality of compartments 32 for storing parcels. The plurality of compartments 32 comprises a compartment door 34 provided with a lock, a locker communication unit 38 for communication with a service point controller 50.

The service point 10 further comprises a service point controller 50. The service point controller 50 comprises a computer readable storage 52 for storing thereon a parcel ID of each of the plurality of parcels and for storing a service point parcel distribution including a parcel position of each of the plurality of parcels within the service point 10.

The service point controller 50 comprises a service point communication unit 54 for wired or wireless communication with the shop instruction unit 24, the locker communication unit 38, third-party devices 80 and optionally, a distribution server 90. The communications in the figures are represented by a lightning bolt, however, that is purely a representation.

The service point controller 50 comprises a service point processor 56 configured to send instructions to the shop instruction unit 24 about refilling the parcel locker 30 as a function of the service point parcel distribution.

The service point controller 50 may further comprise a clock unit 58 such that the service point controller 50 may store a collection event and time of the collection event on the computer readable storage 52, thereby generating local historical event data 70 (not shown in FIG. 2); wherein the service point processor 56 is further configured to send instructions to the shop instruction unit 24 about refilling the parcel locker 30 as a function of the local historical event data 70 and the service point parcel distribution.

The collection event and time of the collection event may also be sent to a distribution server 90 such that the distribution server 90 can collect data relating to the local historical event data 70 and for generating a receiver collection pattern 74 (not shown in FIG. 2) of the receiver of the parcel, which can be used for optimising the service point parcel distribution such that as many parcels are handled through the parcel locker 30 as possible.

In FIG. 2, a receiver of a parcel with specific parcel ID is illustrated in the upper left corner of the figure. The receiver uses a third-party device 80 such as a smart phone or tablet or similar for sending a collection request of a parcel with a parcel ID to the service point controller 50. The service point controller 50 being adapted to perform the following steps as a function of the parcel position of the parcel in the collection request:
transmitting instructions to the locker communication unit 38, which instructions causes the lock of the compartment 32 holding the parcel with the parcel ID to unlock after which the receiver can collect the parcel; or
transmitting instructions to the shop instruction unit 24 for collecting and handing over the parcel with the parcel ID after which the personnel of the parcel shop 20 will collect the parcel from the storage room 22.

The storage room 22 and the parcel locker 30 are shown with a dashed line as the exact positioning within the parcel shop 20 is not important, however, it will be more efficient to have both the storage room 22 and the parcel locker 30 as close to the shop instruction unit 24 as possible.

The service point controller 50 may inform the receiver through the third-party device 80 whether the parcel is placed in the parcel locker 30 or stored 120 in the storage room 22.

FIG. 3 illustrates another embodiment of a service point 10 comprising a parcel shop 20 and a parcel locker 30. The embodiment differs from the embodiment in FIG. 2 by the storage room 22 comprising a plurality of marked parcel positions 1-1, 1-2, 1-3, 2-1 . . . i-j. In the shown embodiment i=[1:7] and j=[1:3], however i,j may be any real number. The numbering may be different as long as each parcel position is unique.

In this case, the service point controller 50 is configured to send instructions to the shop instruction unit 24 about storing a parcel with a specific parcel ID at a specific marked parcel position or the service point controller 50 is configured to receive information of a parcel with specific parcel ID being stored at a marked parcel position such that upon a collection request, the service point controller 50 can provide a specific marked parcel position of the parcel. In the figure, the parcel to be collected is placed in marked parcel position 2-1 as can be seen on the shop instruction unit 24. Thereby, the efficiency of the service point is further increased.

FIGS. 4A-4D illustrate various data which can be utilized by a service point controller 50 for optimising a service point 10 as shown in anyone of FIGS. 1-3 above. FIG. 4A shows that the service point controller 50 will at least comprise a computer readable storage 52 for storing thereon a parcel ID of each of the plurality of parcels and for storing a service point parcel distribution including a parcel position of each of the plurality of parcels within the service point 10 and the service point controller 50 comprises a service point communication unit 54 for wired or wireless communication with the shop instruction unit 24, the locker communication unit 38, third-party devices 80 and optionally, a distribution server 90. The service point controller 50 comprises a service point processor 56 configured to send instructions to the shop instruction unit 24 about refilling the parcel locker 30 as a function of the service point parcel distribution and optionally, other data shown in FIGS. 4B to 4D.

FIG. 4B shows local historical event data 70 of collection events as a function of time, wherein the first axis represents time during a day such as from 06:00 a.m. until 08:00 p.m. depending on the opening hours of the service point. The second axis represents the number of events. The shown graph may be for an entire year and this data is used to predict collection patterns of the receivers. However, the local historical event data 70 may be divided into weekdays and weekends as the collection pattern will typically differ. In this case, the service point processor 56 may be further configured to send instructions to the shop instruction unit 24 about refilling the parcel locker 30 as a function of the local historical event data 70 and the service point parcel distribution such that the parcel locker is filled prior in time to collection events.

FIG. 4C shows a receiver collection pattern connected to a receiver. In the first graph, the first axis represents the different seven days (Monday to Sunday), and the second axis represents collection events. In the second graph, the first axis represents time during a day such as from 06:00 a.m. until 07:00 p.m. depending on the opening hours of the service point. The second axis represents the number of collection events. This specific receiver mainly collects parcels in the weekend and has exclusively collected parcels at or after 05:00 p.m. Thus, a parcel for this receiver should not be placed in a parcel locker 30 until Friday and potentially just before 05:00 p.m. as this will increase a parcel throughput of the parcel locker 30 compared to placing the parcel in the parcel locker on a Wednesday or another weekday. Thus, the step of storing, the step of refilling and/or the step of removing is performed as a function of the receiver collection pattern. For example, if the parcel has not been collected from the parcel locker 30 during the weekend, then, the parcel should be removed from the parcel locker 30.

FIG. 4D shows historical store data 72 of a convenience store or a supermarket or a retail store, wherein the historical store data 72 is inclusive time-sequenced busyness data. The first axis represents time during a day such as from 06:00 a.m. until 08:00 p.m. depending on the opening hours of the service point. The second axis represents the number of events. Thus, the service point 10 can be installed in a convenience store or a supermarket or a retail store and from day 1, be able to predict timeslots with many collection events as there is a correlation between busyness or number of store visits and the number of parcels being collected. Thus, the service point controller 50 is further configured to send instructions to the shop instruction unit 24 about refilling the parcel locker 30 as a function of the historical store data 72 and the service point parcel distribution.

FIG. 5 illustrates a third-party device 80 transmitting a collection request to a service point controller 50 of a service point 10. The figure also illustrates a method 200 for collection of a parcel with a parcel ID at the service point 10. The service point 10 further comprises a parcel shop 20 and a parcel locker 30. The service point 10 may be as shown in FIG. 2 or 3.

In embodiments, the method 200 comprises a step of transmitting 210 a collection request of a parcel with a parcel ID to the service point controller 50. This is performed by the receiver using a third-party device 80 such as a smart phone or tablet.

The device 80 performs a step of receiving 110 from the service point controller 50, a parcel position of the parcel with a parcel ID; wherein one of the following steps is performed by the service point controller 50 as a function of the parcel position
transmitting 210 instructions to the locker communication unit 38, which instruction causes a lock of the compartment 32 holding the parcel with the parcel ID to unlock: or
transmitting 210 instructions to the shop instruction unit 24 for collection and handing over the parcel with the parcel ID; and
This is followed by a step of collecting 220 the parcel with the parcel ID by the receiver.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A service point for distribution of a plurality of parcels, wherein the service point comprises:
a parcel shop being a manned parcel shop for manually handing over parcels, the parcel shop comprising
a storage room for storing the plurality of parcels, and
a shop instruction unit comprising a display for displaying instructions;
a parcel locker positioned inside the parcel shop or positioned in a near vicinity of the parcel shop, the parcel locker comprising
a plurality of compartments for storing parcels and the plurality of compartments comprise a compartment door provided with a lock; and
a locker communication unit; and
a service point controller comprising
a computer readable storage for storing thereon a parcel ID of each of the plurality of parcels and for storing a service point parcel distribution including a parcel position of each of the plurality of parcels within the service point;
a service point communication unit for wired or wireless communication with the shop instruction unit, the locker communication unit, third-party devices and optionally, a distribution server; and
a service point processor configured to send instructions to the shop instruction unit about refilling the parcel locker as a function of the service point parcel distribution.

2. The service point according to claim 1, wherein the service point controller, upon a collection request of a parcel with a parcel ID from a third-party device, is configured to perform the following steps as a function of the parcel position;
transmitting instructions to the locker communication unit, which instructions causes the lock of the compartment holding the parcel with the parcel ID to unlock; or
transmitting instructions to the shop instruction unit for collecting and handing over the parcel with the parcel ID.

3. The service point according to claim 1, wherein the service point controller comprises a clock unit and the service point controller is configured to for storing a collection event and time of the collection event on the computer readable storage, thereby generating local historical event data; wherein the service point processor is further configured to send instructions to the shop instruction unit about refilling the parcel locker as a function of the local historical event data and the service point parcel distribution.

4. The service point according to claim 1, wherein the service point is part of a convenience store or a supermarket or a retail store.

5. The service point according to claim 5, wherein the service point controller receives historical store data of the convenience store or the supermarket or the retail store, where the historical store data including time-sequenced busyness data, and wherein the service point controller is further configured to send instructions to the shop instruction unit about refilling the parcel locker as a function of the historical store data and the service point parcel distribution.

6. The service point according to claim 1, wherein the service point is an autonomous service point and the decision whether a parcel is stored in the storage room or in the parcel locker is decided by the autonomous service point.

7. The service point according to claim 1, wherein the storage room comprises a plurality of marked parcel positions, wherein the service point controller is configured to send instructions to the shop instruction unit about storing a parcel with a specific parcel ID at a specific marked parcel position and/or is configured to receive information of a parcel with specific parcel ID being stored at a marked parcel position.

8. The service point according to claim 1, wherein the service point controller tracks a parcel locker storage time for each parcel stored in the parcel locker, wherein the service point controller is further configured to send instructions to the shop instruction unit about replacing one or more parcels stored in the parcel locker as a function of the parcel locker storage time.

9. A method for controlling a service point parcel distribution at the service point according to claim 1; wherein the method comprises
receiving at the service point the plurality of parcels with parcel IDs;
storing the plurality of parcels in the storage room and the parcel locker; and after a time period, the following step is performed as a function of instructions received by the service point controller;
refilling the parcel locker by placing parcels from the storage room in the parcel locker.

10. The method according to claim 9, wherein the step of refilling is performed as a function of local historical event data and the service point parcel distribution, wherein the local historical event data includes collection events and time of the collection events.

11. The method according to claim 9, wherein the method further comprises steps of
removing a parcel stored from the parcel locker and storing the parcel in the storage room, while storing a parcel from the storage room in the parcel locker;
wherein the step of removing is performed as a function of a parcel locker storage time of the parcels stored in the parcel locker.

12. The method according to claim 2, wherein the method further comprises a step of
receiving a receiver collection pattern of the plurality of parcels from a distribution server, which receiver collection pattern includes historical data for collection times of receivers of the plurality of parcels,
wherein the step of storing, the step of refilling 130) and/or a step of removing is performed as a function of the receiver collection pattern.

13. The method according to claim 9, wherein the method comprises
receiving a preferred collection time slot provided by a receiver of a parcel,
wherein the step of storing, the step of refilling and/or a step of removing is performed as a function of the preferred collection time slot.

14. A method for collection of a parcel with a parcel ID at the service point according to claim 1, wherein the method comprises
transmitting a collection request of a parcel with a parcel ID to the service point controller;
receiving from the service point controller a parcel position of the parcel with a parcel ID; wherein one of the following steps is performed as a function of the parcel position
transmitting instructions to the locker communication unit, which instructions causes the lock of the compartment holding the parcel with the parcel ID to unlock; or
transmitting instructions to the shop instruction unit for collection and handing over the parcel with the parcel ID; and
collecting the parcel with the parcel ID.

15. The method for collection of a parcel according to claim 14, wherein the step of transmitting a collection request is performed by a third-party device, wherein the third-party device is a smart phone or laptop or tablet or a local parcel shop unit.
